(19) United States
(12) Patent Application Publication
(10) Pub. No.: US 2015/0134550 A1
(43) Pub. Date: May 14, 2015

(54) System and Method for Calculating Carbon Footprint

(71) Applicants: Robert Sroufe, Blawnox, PA (US); HAMMEL COMPANIES, INC., PITTSBURGH, PA (US)

(72) Inventor: Robert Sroufe, Blawnox, PA (US)

(73) Assignees: HAMMEL COMPANIES, INC., PITTSBURGH, PA (US); Robert Sroufe, Blawnox, PA (US)

(21) Appl. No.: 14/074,899

(22) Filed: Nov. 8, 2013

(51) Int. Cl. G06Q 30/00

(52) U.S. Cl. CPC G06Q 30/018
USPC 705/317

(57) ABSTRACT

A system and method for determining a total of carbon emissions and water consumption for a customer of a freight carrier includes determining a first plurality of inputs to determine a total of carbon emissions, determine a second plurality of inputs to determine the total of carbon emissions, determining a first amount of carbon associated with each of the first plurality of inputs, determining a second amount of carbon associated with the second plurality of inputs, determining an amount of carbon produced during a shipment of goods, which includes goods of at least one customer of the freight carrier, based on the first amount of carbon and the second amount of carbon, and allocating the amount of carbon produced during the shipment of goods to the at least one customer based on the weight, the volume, and the fuel consumed during the shipment of the at least one customer's goods.

### FIELD OF THE DISCLOSURE

The present disclosure is generally directed towards a system and method for calculating a carbon footprint and water footprint, more particularly, calculating and tracking a carbon footprint in a logistics context.

### BACKGROUND

The growth of consumer interest in environmental sustainability, and global water scarcity combined with government regulations and a stronger sense of corporate sustainability and responsibility, is raising awareness of the role which the transportation industry plays in global sustainability. Multinational corporations now track key sustainability performance metrics for their own operations and those of their suppliers. This growth in interest in environmental sustainability has led to firms such as Walmart realizing over 90% of their emissions are from their supply chain.

There is a continued global interest in improving business management through the reduction of greenhouse gases (“GHG”) that is driving sustainably focused companies to measure and manage their total carbon emissions, or carbon footprint. While environmental and social responsibility is predominately voluntary in North America, environmental mandates in regions such as the European Union have had a far reaching impact on manufacturing and logistics in the United States. The proliferation of U.S. corporate acquisitions by European and Far Eastern companies results in the sustainability policies of these parent organizations reaching around the world. In addition, suppliers of both goods and services to the leading edge sustainable organizations are beginning to see the shift from optional GHG improvement initiatives to required sustainability strategies to remain a viable supply chain partner.

For many manufacturers a significant portion of their true carbon footprint lies in the supply chains feeding materials and distributing products. Specifically, one of the largest contributors of carbon for many manufacturers carbon footprint comes from the logistics services required to properly position materials and finished products in global supply chains. Despite the relatively large contribution of transportation to an overall carbon footprint, one of the major hurdles to tracking supply chain emissions is the lack of standardization for emissions reporting.

Thus, there is a need for an accurate and reliable system and method for calculating and reporting carbon emissions associated with the logistics industry and with freight movement in general.

The present invention is directed toward overcoming one or more of the above-identified problems.

### SUMMARY OF THE INVENTION

The present disclosure provides a system and method for a user to enter carbon dioxide, simply called “carbon”, generating inputs based on periodic totals. These inputs may be set up to be entered manually or imported from various systems.

There are vehicle inputs (miles/gallons) and building inputs (kilowatts, cubic feet, gallons), which may be for example:
Tractor monthly miles and gallons (by unit);
Straight truck monthly miles and gallons (by unit);
Sprinter van monthly miles and gallons (by unit);
Other vehicle monthly miles and gallons (by unit);
Company car monthly miles and gallons (by unit);
Airline travel miles;
Electricity billed monthly (by location);
Natural gas billed monthly (by location);
Propane billed monthly (by location); and
Electricity billed monthly (by location).
Water use billed monthly.

Calculations are set up to convert each input into an amount of carbon emitted. These calculations have been researched for each type of input to find a proper conversion rate. For example, depending on area of the country, region, and state, electricity could have different carbon conversion rates. These conversion rates and calculations are coded into the system or method.

The carbon data can be summarized on a totals sheet. In addition to understanding the carbon totals by input, calculations may be included that estimate the carbon and water saved in comparison to a previous time period. Additionally, a separate dashboard sheet may be provided that shows the carbon data graphically and by mode of transportation and type of truck to help the user understand where and how carbon is being reduced.

Monthly metrics may include, but are not limited to:
Average MPG;
Kilowatt hour(“kWh”) per month (normalized for specific time periods);
Carbon output per shipment;
Carbon output per day;
Estimated carbon savings;
MPG improvement as compared to previous year gallons miles in current period carbon conversion;
kWh improvement as compared to previous year carbon conversion; and
Water consumption improvements to previous year gallons consumed.

As disclosed herein a method for determining a total of carbon emissions for a customer of a freight carrier comprises the steps of receiving a first plurality of inputs to determine a total of carbon emissions and receiving a second plurality of inputs to determine the total of carbon emissions. The first plurality of inputs comprising sources of carbon that are controlled by the freight carrier and the second plurality of inputs comprising sources of carbon that are not controlled by the freight carrier.

The method further comprises determining, via a processor, a first amount of carbon associated with each of the first plurality of inputs based on a carbon conversion factor associated with each of the first plurality of inputs, determining, via the processor, a second amount of carbon associated with the second plurality of inputs based on a carbon conversion factor associated with each of the second plurality of inputs, determining, via the processor, an amount of carbon produced during a shipment of goods, which comprises goods of at least one customer of the freight carrier, based on the first amount of carbon associated with the first plurality of inputs and the second amount of carbon associated with the second plurality of inputs, and allocating, via the processor, the amount of carbon produced during the shipment of goods to the at least one customer based on weight of the at least one customer's goods, volume of the at least one customer's goods, and fuel consumed during the shipment of the at least one customer's goods.

In another preferred embodiment, the first plurality of inputs comprises an amount of fuel consumption and a number of miles driven by at least one vehicle associated with the freight carrier.

In yet another preferred embodiment, the at least one vehicle is a plurality of vehicles and the plurality of vehicles comprises vehicles associated with Less than Truckload (“LTL”) or Full Truckload (“FTL”) freight delivery.

In still another preferred embodiment, the second plurality of inputs comprises an amount of utility service expenditures by the freight carrier.

In a further preferred embodiment, the amount of utility expenditures comprises at least one of electricity, natural gas, propane, and oil.

In yet a further preferred embodiment, determining the first amount of carbon associated with the first plurality of inputs comprises applying a carbon conversion factor for a type of fuel consumed by a vehicle.

In still a further preferred embodiment, determining the first amount of carbon associated with the first plurality of inputs comprises applying a carbon conversion factor based on a number of miles driven by a vehicle.

In another preferred embodiment, determining the second amount of carbon associated with the second plurality of inputs comprises applying a carbon conversion factor for use of a utility service.

In yet another preferred embodiment, the carbon conversion factor is associated with generation of electricity.

In still another preferred embodiment, the carbon conversion factor is dependent upon at least one of location, time of year, and type of natural resource consumed during the generation of electricity.

In a further preferred embodiment, the method further comprises generating a report, where the report summarizes the amount of carbon produced for each of a plurality of shipments of goods during a predetermined period of time.

In yet a further preferred embodiment, the amount of carbon produced during the shipment of goods summarized by the report is an average amount of carbon produced during a shipment of goods and is calculated on a monthly basis.

In still a further preferred embodiment, the at least one customer is a plurality of customers and wherein allocating the amount of carbon produced during the shipment of goods comprises allocating the amount of carbon produced during the shipment of goods to each of the plurality of customers based on a weight of each of the customer's goods, a volume of each of the customer's goods, and fuel consumed during the shipment of each of the customer's goods.

Also disclosed herein, a system for determining a total of carbon emissions for a customer of a freight carrier comprises at least one processor that determines a first plurality of inputs for a function to determine a carbon footprint and determines a second plurality of inputs for the function to determine the carbon footprint. The first plurality of inputs comprise sources of carbon that are controlled by the freight carrier and the second plurality of inputs comprise sources of carbon that are not controlled by the freight carrier.

Additionally, the at least one processor determines a first amount of carbon associated with the first plurality of inputs, determines a second amount of carbon associated with the second plurality of inputs, determines an amount of carbon produced during a shipment of goods, which comprises goods of at least one customer of the freight carrier, based on the first amount of carbon associated with the first plurality of inputs and the second amount of carbon associated with the second plurality of inputs, and allocates the amount of carbon produced during the shipment of goods to the at least one customer based on weight of the at least one customer's goods, volume of the at least one customer's goods, and fuel consumed during the shipment of the at least one customer's goods.

In another preferred embodiment, the at least one customer is a plurality of customers and each of the plurality of customers is associated with a portion of the shipment, and wherein the processor allocates the amount of carbon produced during the shipment of goods to each of the plurality of customers based on a weight of the portion of each customer's goods, a volume of the portion of each customer's goods, and fuel consumed during the shipment of the portion of each customer's goods.

In yet another preferred embodiment, the first plurality of inputs comprises an amount of fuel consumed and a number of miles driven by at least one vehicle controlled by the freight carrier during the shipment of goods.

In still another preferred embodiment, at least one vehicle is a plurality of vehicles and the plurality of vehicles comprises vehicles associated with Less than Truckload (“LTL”) or Full Truckload (“FTL”) freight delivery.

In a further preferred embodiment, the second plurality of inputs comprises an amount of utility service expenditures by the freight carrier.

In yet a further preferred embodiment, the amount of utility expenditures comprises at least one of electricity, natural gas, propane, and oil.

Additionally disclosed herein a system for determining a total of carbon emissions for a customer of a freight carrier comprises a non-transitory computer-readable medium that has instructions stored thereon. If executed by a processor, the instructions cause the processor to determine a first plurality of inputs for a function to determine a carbon footprint and determine a second plurality of inputs for the function to determine the carbon footprint. The first plurality of inputs comprising sources of carbon that are controlled by the freight carrier and the second plurality of inputs comprising sources of carbon that are not controlled by the freight carrier.

Further, the instructions cause the processor to determine a first amount of carbon associated with the first plurality of inputs, determine a second amount of carbon associated with the second plurality of inputs, and determine an amount of carbon produced during a shipment of goods based on the first amount of carbon associated with the first plurality of inputs and the second amount of carbon associated with the second plurality of inputs. The shipment of goods comprises goods of a plurality of customers of the freight carrier and each customer is associated with a portion of the shipment.

The instructions also cause the processor to allocate the amount of carbon produced during the shipment of goods of the plurality of customers based on a weight of the portion of each customer's goods, a volume of the portion of each customer's goods, and fuel consumed during the shipment of the portion of each customer's goods.

Further features, aspects, objects, advantages, and possible applications of the present invention will become apparent from a study of the exemplary embodiments and examples described below, in combination with the figures, and the appended claims.

### BRIEF DESCRIPTION OF THE DRAWINGS

Further possible exemplary embodiments are shown in the drawings. The present invention is explained in the following in greater detail as an example, with reference to exemplary embodiments depicted in drawings. In the drawings:

FIG. 1 is a dataflow chart of a preferred embodiment of the present disclosure;

FIG. 2 is a dataflow chart of a report generating process as used in a preferred embodiment of the present disclosure;

FIG. 3 is a report generated in a preferred embodiment of the present disclosure;

FIG. 4 is a report generated in a preferred embodiment of the present disclosure;

FIG. 5 is a report generated in a preferred embodiment of the present disclosure;

FIG. 6 is a report generated in a preferred embodiment of the present disclosure;

FIG. 7 is a report generated in a preferred embodiment of the present disclosure;

FIG. 8 is a report generated in a preferred embodiment of the present disclosure;

FIG. 9 illustrates a network architecture for various embodiments of the present disclosure; and

FIG. 10 is a component diagram of a computer device that implements various embodiments of the present disclosure.

### DETAILED DESCRIPTION OF THE INVENTION

Exemplary embodiments of the present disclosure relate to systems and methods for determining a carbon footprint, or total of carbon emissions, for a host institution, such as, for example, a freight carrier. As used herein, a freight carrier includes any entity that specializes in the moving, or forwarding, of freight, or cargo, from one place to another. These entities may be divided into several variant sections and include, international and domestic freight forwarders. The method of shipping goods by a freight carrier may include by air, road, sea, and/or rail.

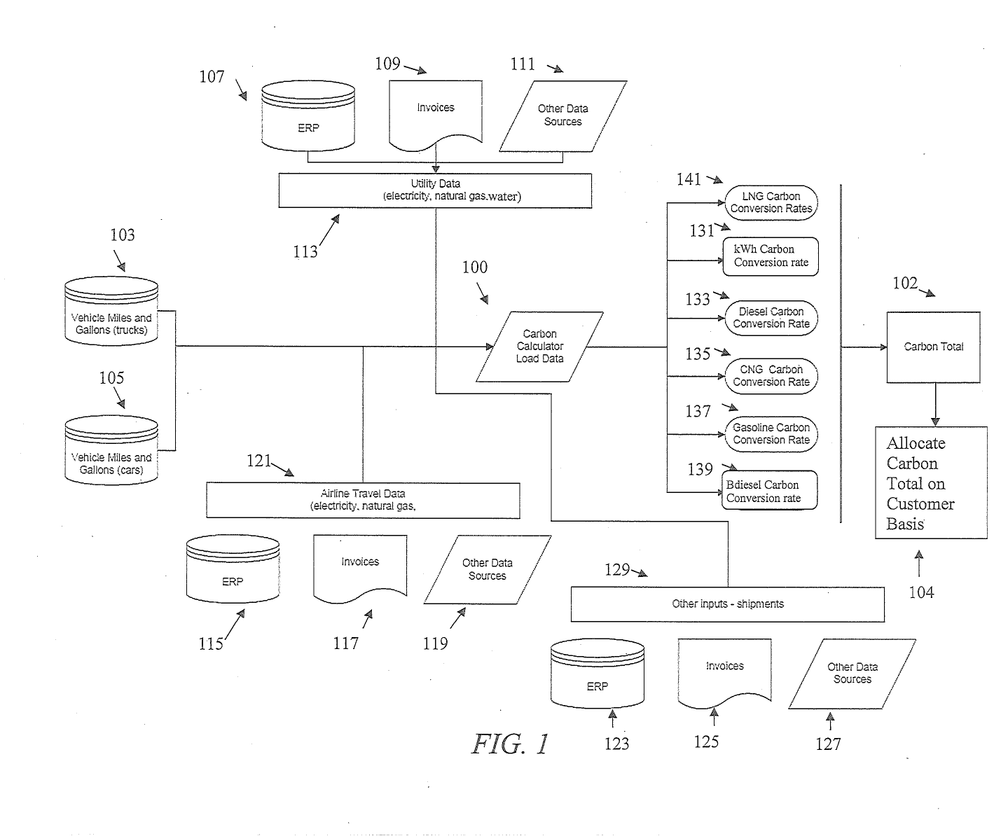

As disclosed herein and as shown in FIG. 1, a system and method for determining a total of carbon emissions for a customer of a freight carrier comprises receiving, at 100, a first plurality of inputs and a second plurality of inputs, at a carbon calculator device to determine the total of carbon emissions of a freight carrier.

The first plurality of inputs comprises sources of carbon in the shipping process that are directly controlled by a freight carrier and the second plurality of inputs comprises sources of carbon in the shipping process that are not directly controlled by the freight carrier. Direct emissions can occur from sources that are owned or controlled by a company, e.g., emissions from combustion in owned or controlled boilers, furnaces, vehicles, etc.; emissions from chemical production in owned or controlled process equipment.

In this context, directly controlled refers to use of the source of the carbon emission in the first degree by a freight carrier. Such sources of carbon emission may be owned, leased, or operated by the freight carrier, its representatives, and/or its contractors during a shipping process. As an example, these emissions may include the results of combustion from boilers, furnaces, and vehicles controlled by the freight carrier along with emissions from processes performed by or products manufactured by the freight carrier.

When the carbon source is not directly controlled by the freight carrier, the source of the carbon emission is more than one degree away from the actions of the freight carrier. As an example, these emissions include carbon produced in generating electricity, where electricity is used during operations related to the shipping process. Electricity indirect emissions are from the generation of purchased electricity consumed by a company. Purchased electricity is defined as electricity that is purchased or otherwise brought into the organizational boundary of the freight carrier. These emissions physically occur at the facility where electricity is generated. Other indirect emissions may include emissions that are a consequence of the activities of a company, but occur from sources not owned or controlled by the company. Nonlimiting examples of these activities include extraction and production of purchased materials; transportation of purchased fuels; and use of sold products and services.

As shown in FIG. 1, the first plurality of inputs may be represented by energy or fuel consumed and distance traveled by vehicles of the freight carrier. This may include both revenue generating vehicles and non-revenue vehicles. In the example of FIG. 1, the first plurality of inputs may consist of vehicle miles driven and gallons of fuel consumed (which may be, for example, gasoline, diesel, propane, liquefied natural gas, etc.) for both cars 105 and trucks 103, respectively. In the instance of alternative fuel vehicles, an appropriate factor may be included. This could be, for example, gallons to electric equivalent for a hybrid or electric vehicle. The first plurality of inputs may also, or alternatively, comprise energy or fuel consumed and distance traveled by other methods of transportation, including other forms of land, air, and sea based transportation. This could include, for example, trains, planes, and boats that would be used in freight delivery by a freight carrier.

As in the example of FIG. 1, the second plurality of inputs may comprise utility data 113 associated with various utility resources that are expended during the entire process of shipping goods by the freight carrier and may comprise an amount of a utility service including water, electricity, and other forms of energy consumed or expended by the freight carrier. Sources of carbon associated with utilities may come from, for example, sources such as the generation of electricity and or the consumption of natural gas, propane, and oil.

Also, the second plurality of inputs may also comprise airline travel data 121 for airline travel taken by employees of the freight carrier. Other inputs for shipments 129 may also be included such as, for example, water consumption and/or individual shipment data for a load such as weight, cube, and density. With the second plurality of inputs, the amount of carbon emissions may also consist of emissions that are not produced in transportation directly, such as those emissions generated during the loading of goods to be shipped. These emissions may be generated by the equipment for used loading goods to be shipped, such as, for example, a forklift or other equipment used at a shipping terminal, or they may consist of utility expenditures associated with buildings or structures that are associated with the freight carrier and shipping process.

In the preferred embodiment of FIG. 1, the system/method further requires that the carbon calculator device determine an amount of carbon associated with each input and provide a total amount of carbon emitted at 102. The total amount of carbon produced or emitted is determined based on the first amount of carbon associated with the first plurality of inputs and the second amount of carbon associated with the second plurality of inputs and. Accordingly, a first amount of carbon associated with each of the first plurality of inputs based on a carbon conversion factor associated with each of the first plurality of inputs is determined, and a second amount of carbon associated with the second plurality of inputs based on a carbon conversion factor associated with each of the second plurality of inputs is determined. As shown, exemplary carbon conversion factors may consist of a carbon conversion rate for Liquefied Natural Gas (“LNG”) 141, Kilowatt hours (“kWh”) 131, Diesel fuel 133, Compressed Natural Gas (“CNG”) 135, Gasoline 137, and/or Biodiesel 139. Depending on its components, Biodiesel (“Bdiesel”) may have a different emission coefficient than regular diesel.

The shipment of goods may comprise goods of one or more customers of the freight carrier, and as such, the system/method shown in FIG. 1 also includes the carbon calculator device allocating the amount of carbon produced during the shipment of goods to a customer of the freight carrier based on weight of the customer's goods, volume of the customer's goods, and fuel consumed during the shipment of the customer's goods, at 104. This process can be repeated based on multiple shipments to provide a customer a total amount of carbon emissions associated with that customer for a predetermined time period, such as, for example, a year.

In a preferred embodiment, allocating the amount of carbon produced during the shipment of goods may comprise allocating the amount of carbon produced during the shipment of goods to each of a plurality of customers based on a weight of each of the customer's goods, a volume of each of the customer's goods, and fuel consumed during the shipment of each of the customer's goods. In addition, fuel consumption may also be broken down by customer miles shipped, volume of the product, and weight of each customer load. Additionally, vehicle type as mpg per vehicle may be different for trucks and straight trucks.

The first plurality of inputs and the second plurality of inputs may be stored in and then gathered from various sources, including Enterprise Resource Planning (“ERP”) databases, invoices records and other data sources. This can also include Materials Requirement Planning (MRP), Environmental Health and Safety (EH&S), Environmental Management Systems (EMS), Sustainable Operating Systems(SOS), and activity based costing accounting systems, invoices records. The process of entering the information that comprises the first and second plurality of inputs may be done manually or it may be imported from various systems and/or databases as discussed herein, such as, for example, an ERP, MRP, EH&S, EMS, or SOS. As shown in the preferred embodiment of FIG. 1, distance traveled and energy or fuel consumed may be stored as vehicles miles and gallons of fuel consumed in separate databases for cars 103 and trucks 105, respectively. Alternatively, this information could be stored in a single database or cloud databases. Similarly, airline travel data 121 may be received from an ERP database 115, invoices for airline travel 117, or other data sources 119 Likewise, utility data 113 and data regarding other inputs for shipments 129 may be received from ERP databases 107, 123 invoices 109, 125 or other data sources 111, 127.

### Vehicles

In a preferred embodiment, the first plurality of inputs comprises an amount of fuel consumption and a number of miles driven by at least one vehicle associated with the freight carrier. The at least one vehicle may be any vehicle involved in pickup, delivery, and line haul operations of a freight carrier. Additionally, the at least one vehicle may be a plurality of vehicles and the plurality of vehicles comprises vehicles associated with Less than Truckload (“LTL”) or Full Truckload (“FTL”) freight delivery. The at least one vehicle may classified as light, medium, and heavy duty trucks including class 1 through 8 of U.S. commercial motor vehicles, which covers the full spectrum of gross vehicle weight ratings. Vehicles involved in freight delivery may include any of land, air, or sea based vehicles, such as, for example, cars, trucks, planes, trains, and boats.

### Carbon Conversion Rates

Determining the first amount of carbon associated with the first plurality of inputs may comprise applying a carbon conversion factor for fuel consumed by a vehicle and/or applying a carbon conversion factor for a distance traveled by a vehicle. In a preferred embodiment, these values may include gallons of gasoline, diesel, or biodiesel fuel and number of miles driven by a delivery truck. In such an example, a carbon conversion for miles driven may be available from sources such as the Environmental Protection Agency (“EPA”), which provides listings for numerous different vehicles and vehicle classes. A typical conversion factor consists of grams of a GHG gas, such as carbon, emitted on a per mile basis. One of ordinary skill in the art would understand how to calculate a proper carbon conversion factor in this context.

Additionally, determining the second amount of carbon associated with the second plurality of inputs comprises may comprise a carbon conversion factor for a specific natural resource consumed during generation or use of a utility service. The utility service provided to the freight carrier may be, as non-limiting examples, natural gas, electricity, water, or oil. In a preferred embodiment, the carbon conversion factor may be associated with generation of electricity. Carbon emissions vary with the amount and type of energy source used in producing electricity and as such, the carbon conversion factor may be dependent upon at least one of location, time of year, and type of resource consumed during the generation of electricity. The grid mix for a particular location determines the appropriate carbon conversion factor or factors that are used. The type of resource consumed may include, for example, coal, natural gas, or other material that is burned or used up during the generation of electricity. Additionally, renewable resources may be used during the generation of electricity and may allow for an offset of some of the carbon emissions caused by the use of other resources.

### Reports

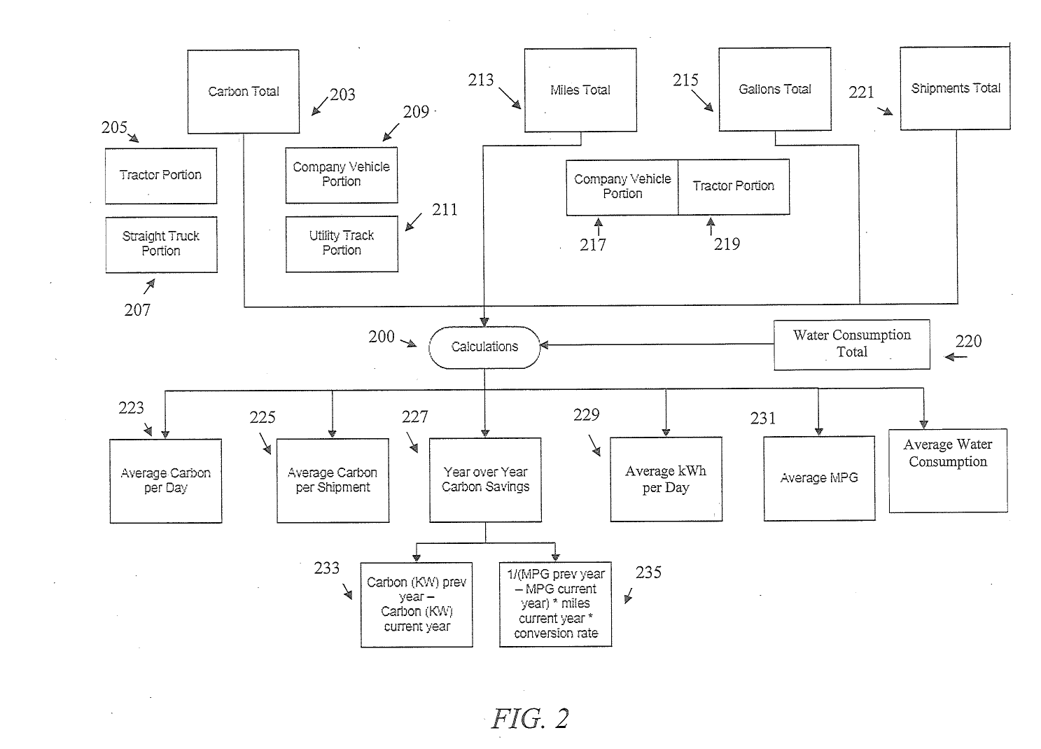

As shown in FIG. 2, reports may be generated based on information received as the first and second plurality of inputs. Information that is valuable in this regard may consist of total carbon emissions for selected sources, distance traveled for selected areas of transportation, energy or fuel consumed during transportation, and other details regarding the transportation, including the number of shipments made in a predetermined amount of time. In the preferred embodiment shown in FIG. 2, generating a report may consist of gathering information from the first and second plurality of inputs and determining totals for each of carbon emissions 203, miles driven 213, gallons of fuel consumed 215, shipments total 221, and water consumption total 220. Shipments total 221 may include total shipments for the transportation company and/or total shipments by customer.

According to FIG. 2, total carbon emissions may include totals of a tractor portion 205, a straight truck portion 207, a company vehicle portion 209, and a utility track portion 211. Additionally, the totals for miles driven and gallons of fuel consumed may include totals of a company vehicle and tractor portions 217 and 219, respectively.

At 200, calculations may then be performed to generate reports based on this information. These reports may consist of any report that summarizes the amount of carbon produced or emitted as part of the operations of the freight carrier during a predetermined period of time. In the preferred embodiment of FIG. 2 and as illustrated in FIGS. 3-8, these reports may consist of such reports as Average Carbon per Day 223, Average Carbon per Shipment 225, Year over Year Carbon Savings 227, Average kWh per Day 229, Average Mile Per Gallon (“MPG”) 231, and Average Water Consumption 232. Averages may be calculated on a yearly, monthly, weekly, or any other basis that is desired.

As shown in FIG. 3, the average MPG of a freight carrier can be represented on a monthly basis. In FIG. 3, a past history of five years of MPG values are shown with 2009, 2010, 2011, 2012, and 2013 shown in line graphs 301, 303, 305, 307, and 309, respectively.

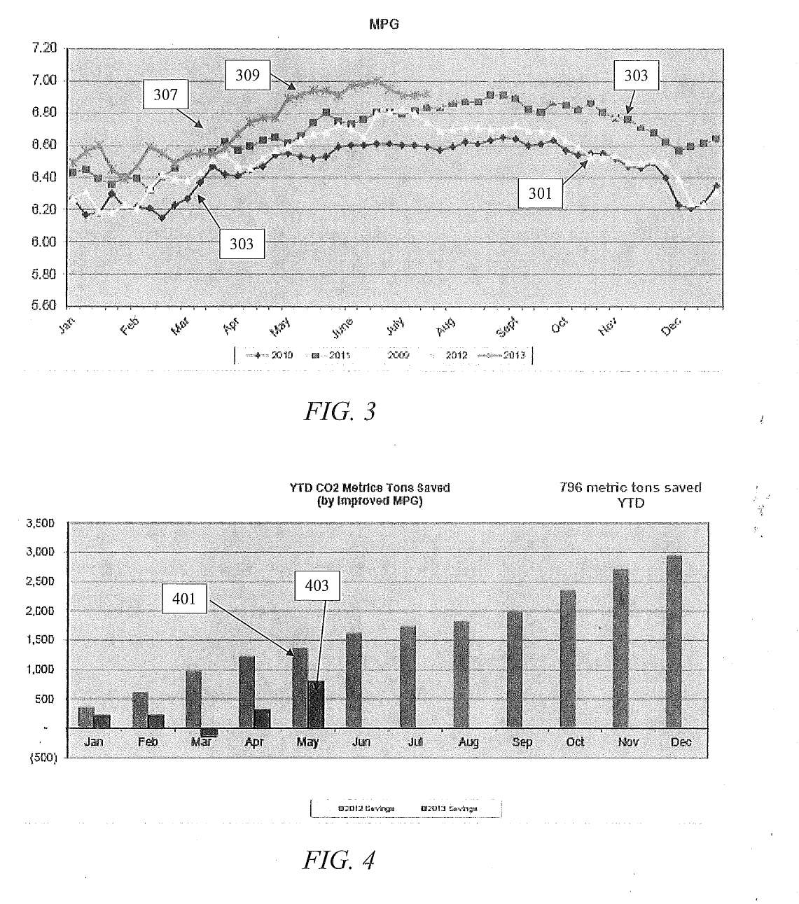

FIG. 4 provides a bar graph of year to date (“YTD”) carbon savings from improved MPG represented in tons saved on a monthly basis. FIG. 4 gives 2012 savings as line 401 and 2013 savings as line 403 on a monthly basis. As shown in 233 of FIG. 2, the Year over Year Carbon Savings 227 report may be calculated as carbon determined based on kWh from a previous year, compared to carbon determined based on kWh from the current year. Additionally or alternatively, as shown by 235, Year over Year Carbon Savings 227 may be calculated as the inverse of MPG from a previous subtracted by MPG of the current year multiplied by miles traveled in the current year, which is multiplied by an appropriate carbon conversion rate.

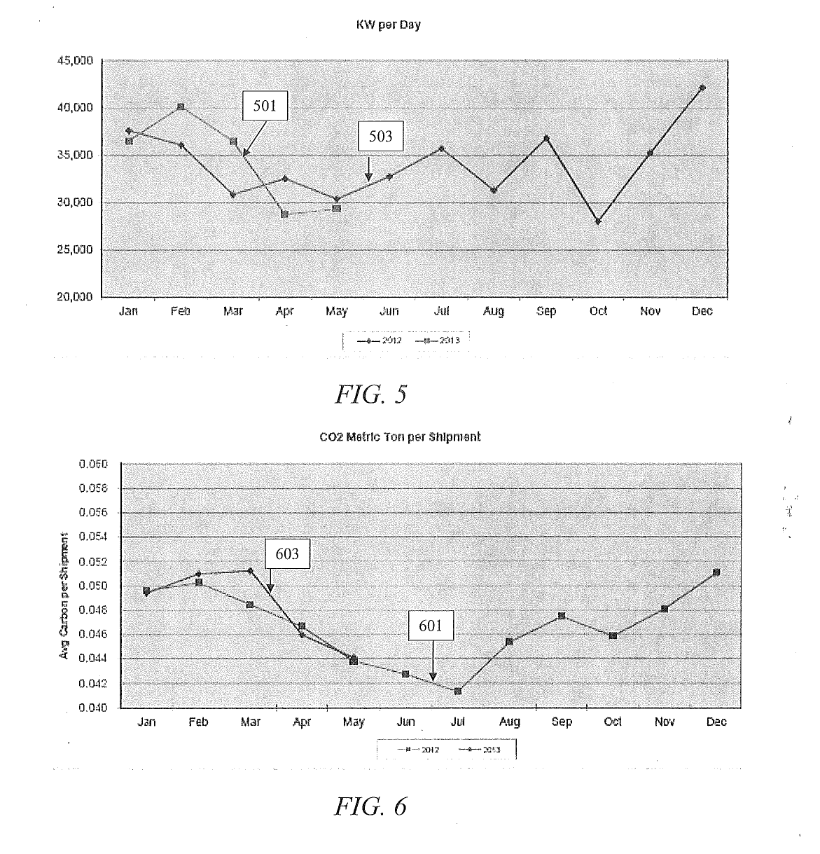

In addition, FIG. 5 gives a summary of average kWh expenditures per day on monthly basis. The average kWh expenditures per day are illustrated by line 501 for 2012 and line 503 for 2013.

FIG. 6 provides a measure of the average amount of carbon produced during a shipment of goods on a monthly basis. Line 601 provides the average kWh expenditures for 2012 and line 603 provides the average kWh expenditures for 2013.

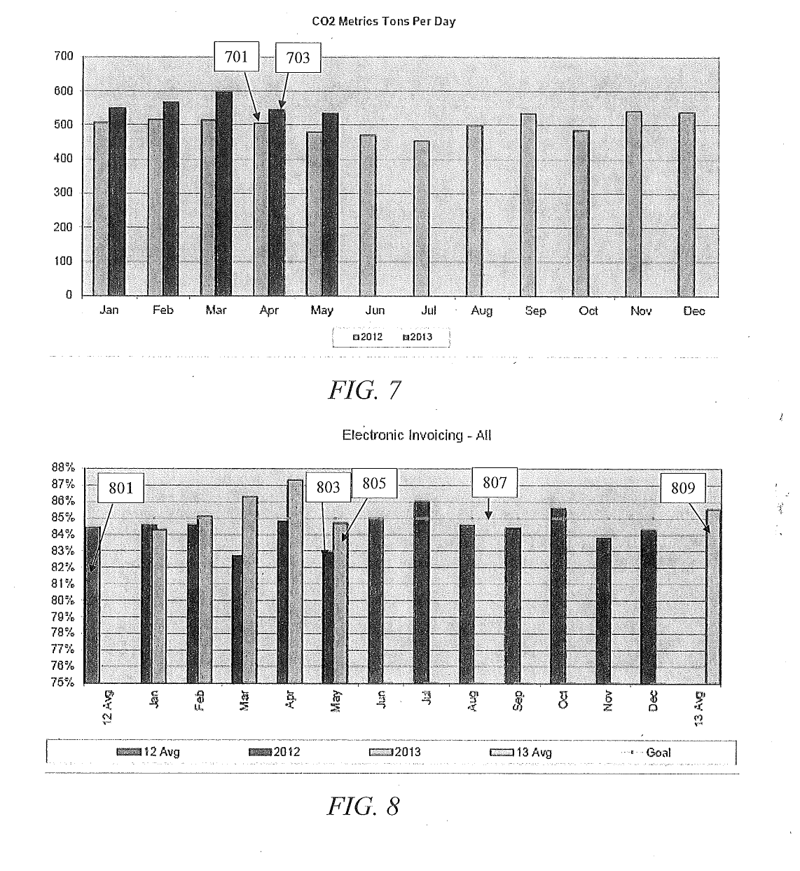

Further, FIG. 7 provides a bar graph that compares carbon in terms of average metric tons emitted per day on a monthly basis. Column 701 represents the average number of tons of carbon emitted per day in 2012 and column 703 represents the average number of tons of carbon emitted per day in 2013.

FIG. 8 provides additional information that may be gathered based on invoices provided to customers of the freight carrier. FIG. 8 is a rolling monthly and annual summary of emissions that provides the ability to see how actual performance compares to an annual average and/or proposed goal.

Based on the reports provided in FIGS. 3-8, and others that may be provided based on the first plurality and second plurality of inputs, future carbon emissions may be predicted for a customer based on particular shipping parameters. These parameters would include one of at least the weight, the volume, the distance, and the method for which the shipment is to be transported. The freight carrier and its customer may then use this information in order to better understand and plan for reductions in carbon emissions produced during the shipping process.

### Network Architecture

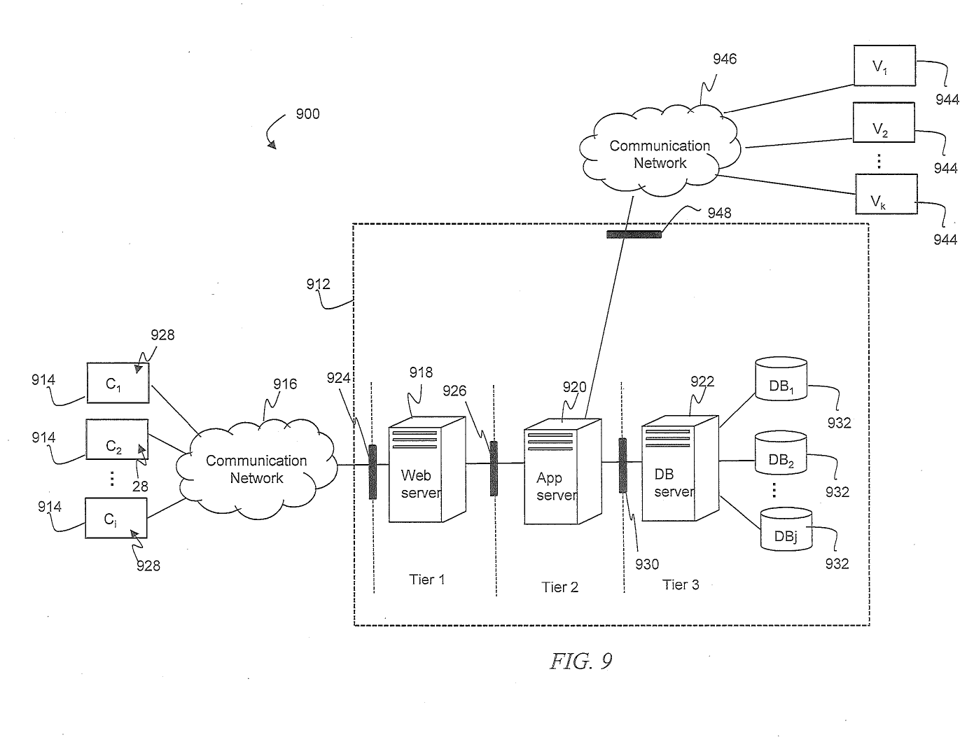

FIG. 9 illustrates network architecture for a system for determining total of carbon emissions for a customer of a freight carrier. FIG. 9 illustrates a system 900 according to embodiments of the present disclosure for providing a determination of total carbon emissions for the operations of a freight carrier, and includes tools and products for providing, managing, and predicting carbon emissions for a freight carrier and customers of the freight carrier. As shown in FIG. 9, the system 900 includes a host system 912 in communication with one or more client devices C₁, C₂ . . . Cᵢ 914 (hereinafter referred to as “clients 914”) via a communications network 916. The communications network 916 may be the Internet, although it will be appreciated that any public or private communication network, using wired or wireless channels, suitable for enabling the electronic exchange of information between the client 914 and the host system 912 may be utilized.

The host system 912 may be implemented by a freight carrier, either locally or remotely, or by another host institution that maintains the system for the freight carrier. The system 912 is configured to provide network-based product and service features to users (e.g., employees of the freight carrier) associated with the clients 914. The clients 914 may include any form of mobile or portable device and any suitable network-enabled devices such as, for example, PCs, laptop computers, palmtop computers, mobile phones, mobile tablets, PDAs, etc. configured to transmit and receive information via the communications network 916 using wired or wireless connections.

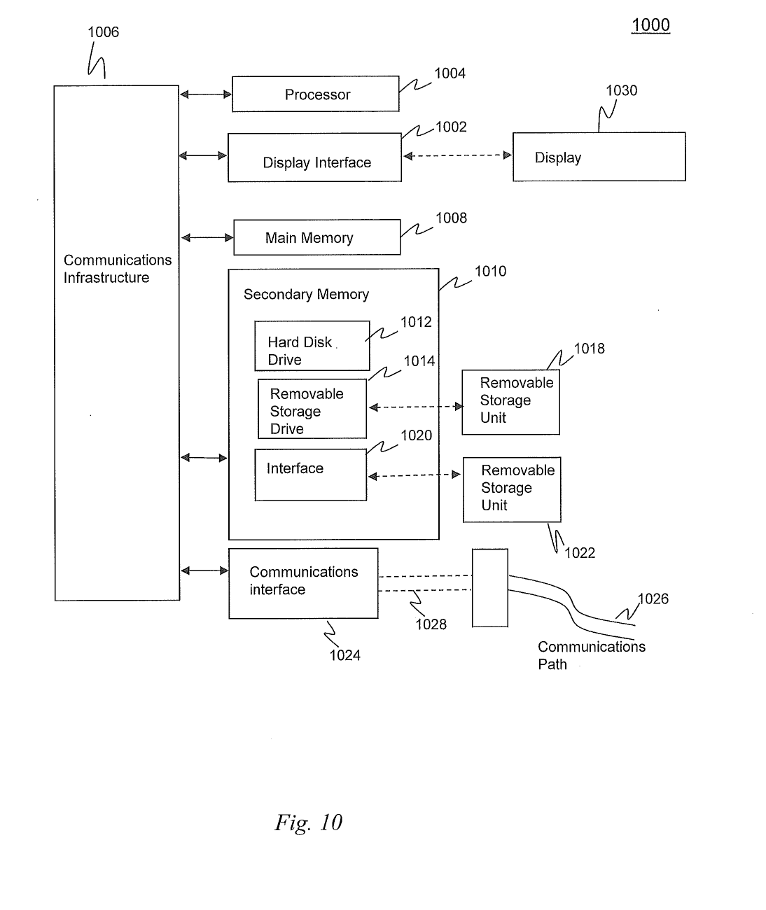

Clients 914 are capable of receiving user input via an input device(s). According to exemplary embodiments, the input device(s) may be one or more of a touch-sensitive display such as a touch screen interface, a keyboard, a microphone, or a pointing device such as a mouse or stylus. Clients 914 also include a display device capable of rendering an interactive Graphical User Interface (“GUI”). The input device may allow a user to interact with a GUI that allows for the input of information as described above with regard to the first plurality and second plurality of inputs. The input device may then be used to instruct the system 900 and 1000, discussed herein with respect to FIGS. 9 and 10, respectively, to display and edit carbon emissions information, which may then be rendered in the display device. For example, a GUI may be rendered in a client 914 via the display device of the client 914. Alternatively, a GUI may be rendered on a display device of one or more servers, such as the web server 918, application server 920, and database server 922 shown in FIG. 9.

In exemplary embodiments, a client 914 can be, but is not limited to, a personal computer (“PC”), a Personal Digital Assistant “(PDA”), a tablet computing device, an iPhone™, an iPod™, an iPad™, a device operating the Android operating system (“OS”) from Google Inc., a device running the Microsoft Windows® Mobile OS, a device running the Microsoft Windows® Phone OS, a device running the Symbian OS, a device running the webOS from Hewlett Packard, Inc., a mobile phone, a BlackBerry® device, a smartphone, a hand held computer, a netbook computer, a palmtop computer, a laptop computer, an ultra-mobile PC, a portable gaming system, or another similar type of mobile computing device having a capability to communicate via the communications network 916.

In some embodiments, the host system 912 may be based on a multi-tiered network architecture, and includes a web server 918 (Tier 1), an application server 920 (Tier 2), and a database server 922 (Tier 3). The web server 918 corresponds to the first tier of the host system 912 and is configured to communicate with the communication network 916 via a border firewall 924, and with the application server 920 via an application firewall 926. The web server 918 may be configured to accept information requests, such as, for example, HTTP requests, from one or more of the clients 914 via the communication network 916 and provide responses thereto. The responses may include, for example, HTTP responses including static and/or dynamic HTML documents for providing a user interface (“UI”) to users via the clients 914. Additionally, the web server 918 may further be configured to authenticate each user before allowing access to a UI and other resources associated with the system 912. Authentication may be performed, for example, by the user inputting a user name and a password.

The application server 920 corresponds to the second tier of the system 912 and is configured to communicate with the web server 918 via the application firewall 926, and with the database server 922 via an internal firewall 930. The application server 922 may host one or more applications executing logic to provide functions regarding determining carbon emissions for a freight carrier and its customers to each client 914. The application server 922 receives user-entered information (e.g., user name and password associated with the user and a request to access particular emissions related features) from a UI of each client 914 via the web server 918. Based on this and other information received from the clients 914, applications hosted by the application server 922 may be invoked to perform transactions on emissions related data (e.g., retrieve invoices, allocate certain data to a particular customer, etc.) and generate corresponding informational content (e.g., user account creation confirmation, reporting information regarding carbon emissions, etc.). Information regarding such transactions may be communicated to the web server 918 and subsequently presented to the users using, for example, a dynamic web page of a UI. Additionally, the application server 922 may also host an application for enabling users to conduct email communication with the host of the system 912, as well as an application for enabling communications with outside parties.

The database server 922 corresponds to the third tier of the system 912 and is configured to communicate with the application server 920 via the internal firewall 930. The database server 922 manages one or more databases DB₁, DB₂ . . . DBᵢ 32 (hereinafter referred to as “databases 932”), which store data to support one or more applications hosted by the application server 920 or elsewhere. Such databases may include, for example, accounting and activity based accounting databases, account information databases, account configuration databases, document identification/authentication databases, customer information databases, user identification/authentication databases, user preferences/settings databases, as well as databases for storing other settings and/or configuration data. Database information requested by a particular application is retrieved from the databases 932 by the database server 922, communicated to the requesting application, and updated by the database server 922 as needed.

The host system 912 may further be connected to a second communication network 946, which is configured to communicate with the application server 920. One or more additional clients V₁, V₂ . . . Vₖ 944 (hereinafter referred to as “clients 944”) external to the system 912 may access the system 912 via a communications network 946 and firewall 948. The communication networks 916 and 946 may be a common communication network (e.g., the Internet). The clients 944 are similar to the clients 928 in all functional aspects.

The clients 914 and 944, may be PCs and/or other network-enabled devices (e.g., cell phones, mobile phones, mobile tablets, PDAs, etc.) configured to transmit and receive information via the communication network 916, 946 using a wired or wireless connection. The clients 914 may include a suitable browser software application (e.g., Internet Explorer, Internet Explorer Mobile, Firefox, Blazer, etc.) for enabling the user to display and interact with information exchanged via the communication networks 916, 946. The clients 914 and 944 may thus access and navigate static and/or dynamic HTML documents of a UI.

### Example Computer System Implementation

As would be appreciated by someone skilled in the relevant art(s) and described below with reference to FIG. 10, part or all of one or more aspects of the methods and system discussed herein may be distributed as an article of manufacture that itself comprises a computer readable medium having computer readable code means embodied thereon.

The computer readable program code means is operable, in conjunction with a computer system, to carry out all or some of the steps to perform the methods or create the system discussed herein. The computer readable medium may be a recordable medium (e.g., hard drives, compact disks, EEPROMs, or memory cards). Any tangible medium known or developed that can store information suitable for use with a computer system may be used. The computer-readable code means is any mechanism for allowing a computer to read instructions and data, such as magnetic variations on a magnetic media or optical characteristic variations on the surface of a compact disk. The medium can be distributed on multiple physical devices (or over multiple networks). For example, one device could be a physical memory media associated with a terminal and another device could be a physical memory media associated with a processing center.

The computer systems and servers described herein each contain a memory that will configure associated processors to implement the methods, steps, and functions disclosed herein. Such methods, steps, and functions can be carried out, e.g., by processing capability on mobile devices, a processor of a computer device, a processor of a general purpose computer, or a special purpose processor designed and configured to perform the task at hand or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor.

Aspects of the present disclosure discussed in FIGS. 1-9, or any part(s) or function(s) thereof, may be implemented using hardware, software modules, firmware, tangible computer readable media having instructions stored thereon, or a combination thereof and may be implemented in one or more computer systems or other processing systems. As an example, the Carbon Calculator functions described above may be performed by a processor of a computer device or system.

FIG. 10 illustrates an example computer system 1000 in which embodiments of the present disclosure, or portions thereof, may be implemented as computer-readable code. For example, the various aspects of the methods described herein can be implemented in computer system 1000 using hardware, software, firmware, non-transitory computer readable media having instructions stored thereon, or a combination thereof and may be implemented in one or more computer systems or other processing systems. Hardware, software, or any combination of such may embody any of the modules and components used to implement the network, systems, and methods.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments. A processor device may be a single processor, a plurality of processors, or combinations thereof. Processor devices may have one or more processor “cores.”

Various embodiments of the present disclosure are described in terms of this example computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

The computer system 1000 includes a display 1030 connected to a communications infrastructure 1006 via a display interface 1002. In an embodiment, the display 130, in conjunction with the display interface 1002, provides a User Interface (“UI”) (not shown). The computer system 1000 also includes a processor device 1004 connected to the communications infrastructure 1006. The processor device 1004 may be a special purpose or a general purpose processor device. As will be appreciated by persons skilled in the relevant art, processor device 1004 may also be a single processor in a multi-core/multiprocessor system, such system operating alone, or in a cluster of computing devices operating in a cluster or server farm. Processor device 1004 is connected to a communication infrastructure 1006, for example, a bus, message queue, network, or multi-core message-passing scheme.

The computer system 1000 also includes a main memory 1008, for example, random access memory (“RAM”), and may also include a secondary memory 1010. Secondary memory 1010 may include, for example, a hard disk drive 1012, removable storage drive 1014. Removable storage drive 1014 may comprise a floppy disk drive, a magnetic tape drive, an optical disk drive, a flash memory, or the like.

The removable storage drive 1014 may read from and/or writes to a removable storage unit 1018 in a well-known manner. The removable storage unit 1018 may comprise a floppy disk, magnetic tape, optical disk, Universal Serial Bus (“USB”) drive, flash drive, memory stick, etc. which is read by and written to by removable storage drive 1014. As will be appreciated by persons skilled in the relevant art, the removable storage unit 1018 includes a non-transitory computer usable storage medium having stored therein computer software and/or data.

In alternative implementations, the secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that found in video game devices), a removable memory chip (such as an EPROM, or PROM) and associated socket, and other removable storage units 1022 and interfaces 1020 which allow software and data to be transferred from the removable storage unit 1022 to computer system 1000.

The computer system 1000 may also include a communications interface 1024. The communications interface 1024 allows software and data to be transferred between the computer system 1000 and external devices based on communication networks. The communications interface 1024 may include a modem, a network interface (such as an Ethernet card), a communications port, a PCMCIA slot and card, or the like. Software and data transferred via the communications interface 1024 may be in the form of signals 1028, which may be electronic, electromagnetic, optical, or other signals capable of being received by communications interface 1024. These signals may be provided to the communications interface 1024 via a communications path 1026. The communications path 1026 carries signals and may be implemented using wire or cable, fiber optics, a phone line, a cellular/wireless phone link, an RF link or other communications channels.

In this document, the terms ‘computer readable storage medium,’ ‘computer program medium,’ ‘non-transitory computer readable medium,’ and ‘computer usable medium’ are used to generally refer to tangible and non-transitory media such as removable storage unit 1018, removable storage unit 1022, and a hard disk installed in hard disk drive 1012. Signals 1028 carried over the communications path 1026 can also embody the logic described herein. The computer readable storage medium, computer program medium, non-transitory computer readable medium, and computer usable medium can also refer to memories, such as main memory 1008 and secondary memory 1010, which can be memory semiconductors (e.g. DRAMs, etc.). These computer program products are means for providing software to computer system 1000.

Computer programs (also called computer control logic and software) are generally stored in a main memory 1008 and/or secondary memory 1010. The computer programs may also be received via a communications interface 1024. Such computer programs, when executed, enable computer system 1000 to become a specific purpose computer able to implement the present disclosure as discussed herein. In particular, the computer programs, when executed, enable the processor device 1004 to implement the processes of the present disclosure discussed below. Accordingly, such computer programs represent controllers of the computer system 1000. Where the present disclosure is implemented using software, the software may be stored in a computer program product and loaded into the computer system 1000 using the removable storage drive 1014, interface 1020, and hard disk drive 1012, or communications interface 1024.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Although the present invention is illustrated and described herein with reference to specific embodiments, the invention is not intended to be limited to the details shown. Rather, various modifications may be made in the details within the scope and range equivalents of the claims and without departing from the invention.

I/We claim:

1. A method for determining a total of carbon emissions for a customer of a freight carrier comprising the steps of:
receiving a first plurality of inputs to determine a total of carbon emissions, the first plurality of inputs comprising sources of carbon that are controlled by the freight carrier;
receiving a second plurality of inputs to determine the total of carbon emissions, the second plurality of inputs comprising sources of carbon that are not controlled by the freight carrier;
determining, via a processor, a first amount of carbon associated with each of the first plurality of inputs based on a carbon conversion factor associated with each of the first plurality of inputs;
determining, via the processor, a second amount of carbon associated with the second plurality of inputs based on a carbon conversion factor associated with each of the second plurality of inputs;
determining, via the processor, an amount of carbon produced during a shipment of goods based on the first amount of carbon associated with the first plurality of inputs and the second amount of carbon associated with the second plurality of inputs, wherein the shipment of goods comprises goods of at least one customer of the freight carrier; and
allocating, via the processor, the amount of carbon produced during the shipment of goods to the at least one customer based on weight of the at least one customer's goods, volume of the at least one customer's goods, and fuel consumed during the shipment of the at least one customer's goods.

2. The method of claim 1, wherein the first plurality of inputs comprises an amount of fuel consumption and a number of miles driven by at least one vehicle associated with the freight carrier.

3. The method of claim 2, wherein the at least one vehicle is a plurality of vehicles and the plurality of vehicles comprises vehicles associated with Less than Truckload (“LTL”) or Full Truckload (“FTL”) freight delivery.

4. The method of claim 1, wherein the second plurality of inputs comprises an amount of utility service expenditures by the freight carrier.

5. The method of claim 4, wherein the amount of utility expenditures comprises at least one of electricity, natural gas, propane, and oil.

6. The method of claim 1, wherein determining the first amount of carbon associated with the first plurality of inputs comprises applying a carbon conversion factor for a type of fuel consumed by a vehicle.

7. The method of claim 1, wherein determining the first amount of carbon associated with the first plurality of inputs comprises applying a carbon conversion factor based on a number of miles driven by a vehicle.

8. The method of claim 1, wherein determining the second amount of carbon associated with the second plurality of inputs comprises applying a carbon conversion factor for use of a utility service.

9. The method of claim 8, wherein the carbon conversion factor is associated with generation of electricity.

10. The method of claim 9, wherein the carbon conversion factor is dependent upon at least one of location, time of year, and type of natural resource consumed during the generation of electricity.

11. The method of claim 1, further comprising generating a report, where the report summarizes the amount of carbon produced for each of a plurality of shipments of goods during a predetermined period of time.

12. The method of claim 11, wherein the amount of carbon produced during the shipment of goods summarized by the report is an average amount of carbon produced during a shipment of goods and is calculated on a monthly basis.

13. The method of claim 1, wherein the at least one customer is a plurality of customers and wherein allocating the amount of carbon produced during the shipment of goods comprises allocating the amount of carbon produced during the shipment of goods to each of the plurality of customers based on a weight of each of the customer's goods, a volume of each of the customer's goods, and fuel consumed during the shipment of each of the customer's goods.

14. A system for determining a total of carbon emissions for a customer of a freight carrier, the system comprising:
at least one processor; and
wherein the at least one processor determines a first plurality of inputs for a function to determine a carbon footprint, the first plurality of inputs comprising sources of carbon that are controlled by the freight carrier;
wherein the at least one processor determines a second plurality of inputs for the function to determine the carbon footprint, the second plurality of inputs comprising sources of carbon that are not controlled by the freight carrier;
wherein the at least one processor determines a first amount of carbon associated with the first plurality of inputs;
wherein the at least one processor determines a second amount of carbon associated with the second plurality of inputs;
wherein the at least one processor determines an amount of carbon produced during a shipment of goods based on the first amount of carbon associated with the first plurality of inputs and the second amount of carbon associated with the second plurality of inputs, wherein the shipment of goods comprises goods of at least one customer of the freight carrier;
wherein the at least one processor allocates the amount of carbon produced during the shipment of goods to the at least one customer based on weight of the at least one customer's goods, volume of the at least one customer's goods, and fuel consumed during the shipment of the at least one customer's goods.

15. The system of claim 14, wherein the at least one customer is a plurality of customers and each of the plurality of customers is associated with a portion of the shipment, and wherein the processor allocates the amount of carbon produced during the shipment of goods to each of the plurality of customers based on a weight of the portion of each customer's goods, a volume of the portion of each customer's goods, and fuel consumed during the shipment of the portion of each customer's goods.

16. The system of claim 14, wherein the first plurality of inputs comprises an amount of fuel consumed and a number of miles driven by at least one vehicle controlled by the freight carrier during the shipment of goods.

17. The system of claim 16, wherein the at least one vehicle is a plurality of vehicles and the plurality of vehicles comprises vehicles associated with Less than Truckload (“LTL”) or Full Truckload (“FTL”) freight delivery.

18. The system of claim 14, wherein the second plurality of inputs comprises an amount of utility service expenditures by the freight carrier.

19. The system of claim 18, wherein the amount of utility expenditures comprises at least one of electricity, natural gas, propane, and oil.

20. A system for determining a total of carbon emissions for a customer of a freight carrier, the system comprising:
a non-transitory computer-readable medium having instructions stored thereon, that, if executed by a processor, cause the processor to:
determine a first plurality of inputs for a function to determine a carbon footprint, the first plurality of inputs comprising sources of carbon that are controlled by the freight carrier;
determine a second plurality of inputs for the function to determine the carbon footprint, the second plurality of inputs comprising sources of carbon that are not controlled by the freight carrier;
determine a first amount of carbon associated with the first plurality of inputs;
determine a second amount of carbon associated with the second plurality of inputs;
determine an amount of carbon produced during a shipment of goods based on the first amount of carbon associated with the first plurality of inputs and the second amount of carbon associated with the second plurality of inputs, the shipment of goods comprising goods of a plurality of customers of the freight carrier, wherein each customer is associated with a portion of the shipment;
allocate the amount of carbon produced during the shipment of goods of the plurality of customers based on a weight of the portion of each customer's goods, a volume of the portion of each customer's goods, and fuel consumed during the shipment of the portion of each customer's goods.
